(19) United States
(12) Patent Application Publication
(10) Pub. No.: US 2007/0210753 A1
(43) Pub. Date: Sep. 13, 2007

(54) Adding a second battery to the equipment of any vehicle which requires a battery to start the engine

(76) Inventor: Anthony Gerome Edwards, Marina Del Rey, CA (US)

Correspondence Address: ANTHONY EDWARDS;#153, 13700 TAHITI WAY, MARINA DEL REY, CA, 90292, US

(21) Appl. No.: 11/373,250

(22) Filed: Mar. 10, 2006

(51) Int. Cl. H02J 7/00

(52) U.S. Cl. 320/126

(57) ABSTRACT

This invention is simply to add a second battery to any vehicle which requires a battery to start the engine. It is simply a reserve source of energy for the times when the primary battery of a vehicle for whatever reason has lost it's charge and needs a boost to start the vehicle and build up a new charge.

The invention is the addition of a second battery to the equipment of any vehicle which requires a battery to start the engine. The second battery is charged off the generator in the same manner as the primary battery but there is nothing connected to it to draw off the charge. It is a reserve source of energy for the infrequent times when something which draws current during normal operation is accidentally left on for a long period of time and draws all the current out of the primary battery leaving nothing to start the engine when next attempted. The size of the second battery is optional as long as it maintains enough of a charge to start a motor with a dead battery.

### BACKGROUND OF THE INVENTION

In today's world where we all own a vehicle of some kind to get around in we all have at one time or another made the mistake of leaving some electrical unit in the “on” position when we retired for the evening and awakened the next morning to a dead battery. As things exist today we call motor assistance of some kind and wait around for their arrival.

With a second battery we simply throw a switch which cuts the connection of the second battery to the charger and changes it to the primary battery where it can give it the necessary boost and we're on our way.

### OBJECT OF INVENTION

The object of the invention is simply to have some easy method of solving the problem where we have left an electrical unit in our vehicle in the “on” position for a long period of time resulting in a dead battery and we need a boost to get our vehicle running again.

### SUMMARY OF INVENTION

The invention is a method of solving the problem of a dead battery in our vehicle which is the result of leaving some electrical feature in the “on” position for too long a period of time when the vehicle is not running and subsequently the battery is not being charged.

This is accomplished by adding a second battery to the equipment in the vehicle which is connected to the generator or charging device so that it is being kept in a charged state at all time but has nothing connected to it that will draw from it's electrical supply.

If the primary battery is dead you simply throw a switch which connects the second battery to the plus and minus terminals of the primary battery where it can supply the necessary boost.

This second battery should be installed in such a way that it is easily accessible to the primary battery. This can be done with permanent cables or it can be simply charged by the generator and when needed can be accessed with a pair or ordinary jumper cables supplied by the manufacturer of the vehicle to connect it from the plus and minus of the second battery to the plus and minus of the primary battery.

The second battery should be installed in such a way that it can be easily disconnected and removed from it's resting place and used as a portable electrical supply for any electrical equipment it might be capable of operating. For example, if a person uses a small boat that is powered by an electric motor the second battery is always ready and available in a fully charged condition. While the batteries used in this invention can be of many different sizes, types and powers and there are many different ways of installing and arranging the electrical connections to maintain the battery in a charged state and supply the electrical charge to the primary battery it does not change the essence of the invention which is to supply a second battery to the vehicle for use when needed.

What I claim as my invention is:

1. In any vehicle with a engine which is started by the use of a battery the improvement is
1. the addition of a second battery
2. the addition of a second battery to be charged along with the primary battery to act as a back-up battery
3. the addition of a back-up battery to boost the primary battery if the primary battery it loses its charge
4. the addition of a second removable portable battery to be used primarily as a support battery for the primary battery if the primary battery loses its charge and for a portable power supply for any electrical equipment it may be capable of operation
5. the addition of a second permanent or removable battery of any type or size to the equipment of a vehicle for use as a back-up battery for a dead primary battery or for use in operating as a portable electrical supply for any items it is capable of operating
